(19) United States
(12) Patent Application Publication
(10) Pub. No.: US 2017/0305746 A1
(43) Pub. Date: Oct. 26, 2017

(54) METHOD FOR MAKING GRAPHENE

(71) Applicant: Foxconn Technology Co., Ltd., New Taipei (TW)

(72) Inventors: NIEN-TIEN CHENG, New Taipei (TW); MING-HSIU CHUNG, New Taipei (TW)

(21) Appl. No.: 15/410,417

(22) Filed: Jan. 19, 2017

Related U.S. Application Data
(60) Provisional application No. 62/325,477, filed on Apr. 21, 2016.

(51) Int. Cl. C01B 32/19

(52) U.S. Cl. CPC C01B 32/19

(57) ABSTRACT

A method for making graphene comprises providing and stacking alternately a plurality of polyimide films and a plurality of carbon papers to form a laminate and conducting carbonization treatment to the laminate to form a intermediate product. The intermediate product is subjected to graphitization treatment to form a polyimide artificial graphite which can be stripped to achieve a graphene.

### FIELD

The subject matter generally relates to a method for making graphene.

### BACKGROUND

Graphene is a collection of carbon atoms hexagonally arranged through sp2 bonds and forming a monolayer sheet-like crystal, or a plurality of the sheets can be piled up and thus superior in electrical and physical characteristics. Graphene can be applied to and in various devices. Graphene is generally made by stripping natural or artificial graphite.

### BRIEF DESCRIPTION OF THE DRAWINGS

Implementations of the present technology will now be described, by way of example only, with reference to the attached figures.

FIG. 1 is a flow chart of a method for making graphene.

FIG. 2 is an X-ray diffractometer spectra graph of a polyimide (PI) artificial graphite of a first embodiment.

FIG. 3 is a Raman spectra graph of the PI artificial graphite of the first embodiment.

FIG. 4 is a scanning electron microscope image of the PI artificial graphite of the first embodiment.

FIG. 5 is a scanning electron microscope image of graphene made by the PI artificial graphite of the first embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like.

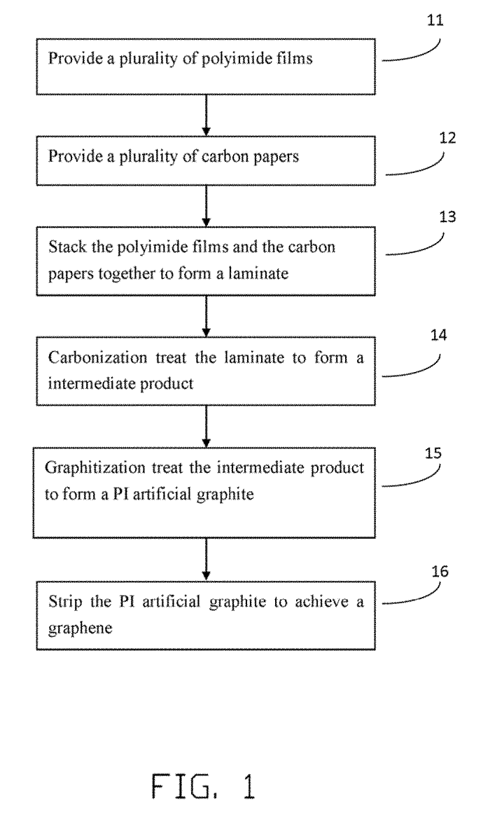

Referring to FIG. 1, a flowchart of a method for making graphene is presented in accordance with an exemplary embodiment. The example method is provided by way of example, as there are a variety of ways to carry out the method. Various elements of these figures are referenced in explaining example method. Each block shown in FIG. 1 represents one or more processes, methods, or subroutines, carried out in the example method. Furthermore, the order of blocks is illustrative only and the order of the blocks can change. Additional blocks can be added or fewer blocks may be utilized, without departing from this disclosure. The example method can begin at block 11.

At block 11, a plurality of polyimide (PI) films are provided. The polyimide films are cut into a predetermined size. The PI film has a thickness of about 10 μm to about 100 μm.

At block 12, a plurality of carbon papers are provided. The carbon paper is cut into the same size as the PI film.

At block 13, the PI films and the carbon papers are stacked alternately together, thereby a laminate is achieved. Between two adjacent carbon papers of the laminate, there are at least ten layers of PI films. The carbon paper between the PI films is configured to transfer heat to the PI films, thereby ensuring that all of the PI films are heated.

At block 14, the laminate is subjected to carbonization treatment. During the carbonization treatment, the PI films in the laminate are thermally decomposed and carbonated, thereby an intermediate product is achieved. The intermediate product is mainly made up of carbon. The laminate is put into a heating chamber of a vacuum carbonization furnace (not shown), and the heating chamber is heated to a carbonization temperature of about 800 degrees Celsius (° C.) to about 2000° C. In other words, the carbonization temperature is in a range from about 800° C. to about 2000° C. The temperature of the heating chamber rises up to the carbonization temperature from room temperature (25° C.) over a period of about 9 hours to about 15 hours. The laminate is heated at the carbonization temperature for about 40 hours to about 50 hours.

At block 15, the intermediate product is subjected to graphitization treatment. During the graphitization treatment, the carbon of the intermediate product is converted into a graphite structure, thereby a PI artificial graphite is achieved. The intermediate product is put into a heating cavity of a high temperature graphite furnace, and the heating cavity is heated to a graphitization temperature of about 2000° C. to about 3300° C. Thus the graphitization temperature is in a range from about 2000° C. to about 3300° C. The high temperature graphite furnace heats the intermediate product by a high frequency heating method. The temperature of the furnace rises up to the graphitization temperature from room temperature (25° C.) over a period of about 6 hours to about 12 hours. The intermediate product is heated at the graphitization temperature for about 50 hours to about 60 hours.

The PI artificial graphite made in the exemplary embodiment has an adhesively layered structure, so the PI artificial graphite can be easily stripped, and a large surface area of graphene can be achieved. The PI artificial graphite made in the exemplary embodiment has few lattice defects. The PI artificial graphite has a thickness of about 5 μm to about 70 μm. The PI artificial graphite has a planar heat conduction coefficient in a range of about 1200 W/(m*K) to about 1600 W/(m*K). The vertical heat conduction coefficient is in a range of about 10 W/(m*K) to about 15 W/(m*K).

At block 16, the PI artificial graphite is stripped to achieve graphene. The method of stripping the PI artificial graphite may be one of mechanical stripping, oxidation reduction, liquid phase separation, thermal delamination, super critical delamination, or super high acoustic wave vibration delamination.

In at least one exemplary embodiment, the method of stripping the PI artificial graphite to achieve graphene is super high acoustic wave vibration delamination. The super high acoustic wave vibration delamination includes the following steps:

First, the manufactured PI artificial graphite is cut into smaller pieces and added into a solvent, thereby a semi-solid liquid mixture is achieved. The PI artificial graphite has a mass percentage of about 0.01% to about 2% of the total mass of the semi-solid liquid mixture. The solvent may be water, N-methyl-2-pyrrolidone (NMP), or 1-butyl-3-methyl-imidazolium bis(trifuoromethanesulfonyl)imide ([Bmim]Tf₂N).

The semi-solid liquid mixture is put in a high energy separator (not shown) to be stripped. Electrical power of about 200 W to about 900 W is applied in the high energy separator. The semi-solid liquid mixture is stripped by the high energy separator for about 1 minute to about 30 minutes, thereby a graphene suspension is achieved.

Electronic components can be made directly from the graphene suspension made above.

In at least one exemplary embodiment, the super high acoustic wave vibration delamination also includes a step of centrifugal separation of the graphene suspension. After the step of centrifugal separation, the solid graphene and the solvent are separated. The graphene suspension is centrifuged at a rotational speed of about 500 revolutions per minute (rpm) to about 15000 rpm. The solid graphene can further be dried to remove the solvent. Then the thickness and surface area of each graphene piece can be measured. The planar heat conduction coefficient of the graphene can also be measured.

### Embodiment 1

A plurality of PI films and a plurality of carbon papers were provided. The PI films and the carbon papers were alternately stacked together to form a laminate. 10 layers of PI films were between each two adjacent carbon papers.

The laminate was put into a heating chamber for vacuum carbonization, the heating chamber was heated for 11 hours from room temperature until a carbonization temperature of 1500° C. was achieved, and then the laminate was heated at the carbonization temperature of 1500° C. for 48 hours. An intermediate product was thereby achieved.

The intermediate product was put into a high temperature graphite furnace. The intermediate product was heated by high frequency heating method for 9 hours from room temperature until a graphitization temperature of 2800° C. was achieved, and then the intermediate product was heated at the graphitization temperature of 2800° C. for 56 hours, thereby a PI artificial graphite was achieved.

The PI artificial graphite was cut into smaller pieces and added into water to form a semi-solid liquid mixture. The PI artificial graphite had a mass percentage of 0.1% of the total mass of the semi-solid liquid mixture. The semi-solid liquid mixture was put into a high energy separator, and electrical power of 200 W was applied to the high energy separator. Then the semi-solid liquid mixture was stripped by the high energy separator for about 5 minutes, thereby a graphene suspension was achieved. Further, the graphene suspension was subjected to centrifugal separation at a rotational speed of about 1000 rpm, thereby solid graphene was achieved.

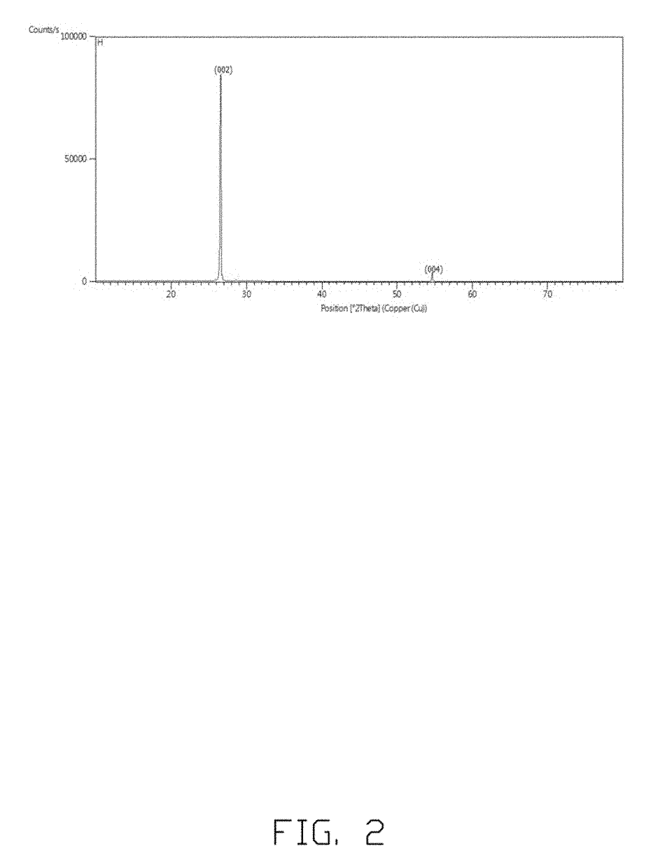

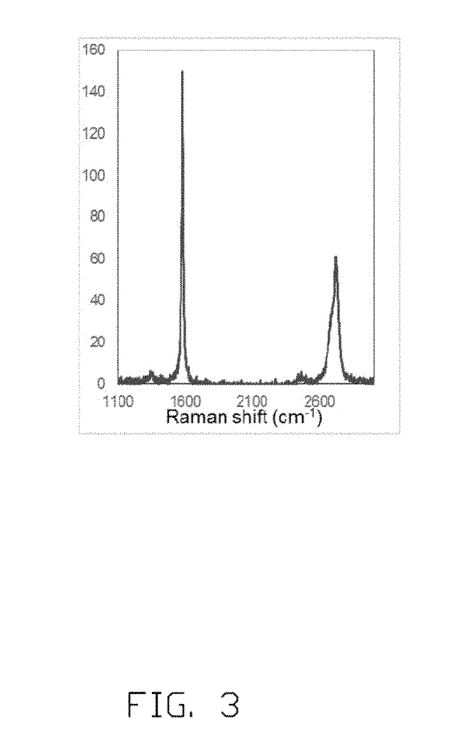

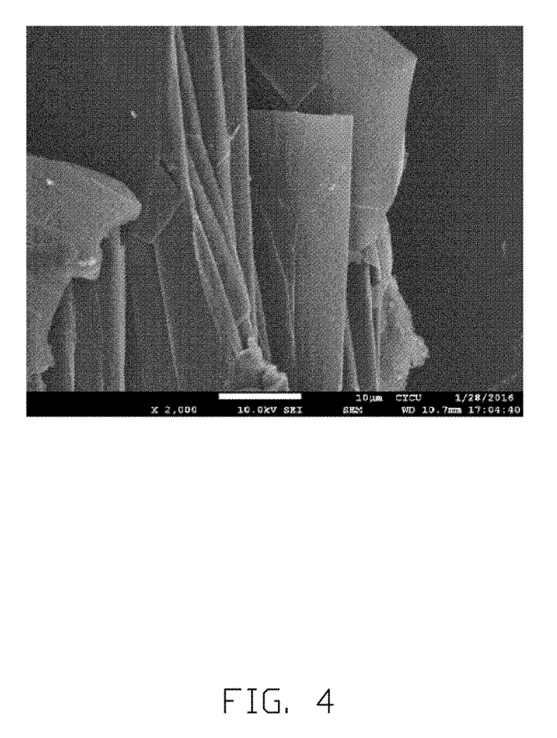

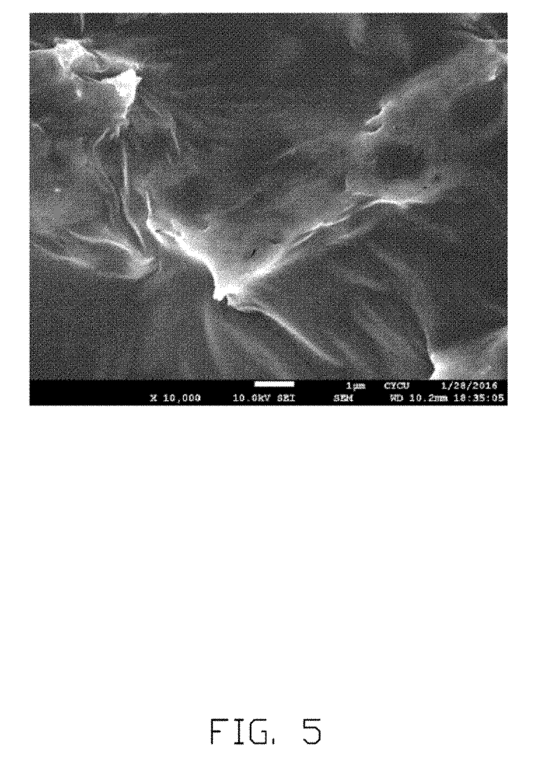

Referring to FIG. 2, the PI artificial graphite is made up of graphite crystals, and the crystallinity is high. Referring to FIG. 3, the PI artificial graphite has few lattice defects, the thickness of the PI artificial graphite is homogeneous. Referring to FIG. 4, the PI artificial graphite is made up of pieces of graphite. Referring to FIG. 5, the surface of the graphene is silk-like smooth, and the graphene has the properties of thin graphene.

### Embodiment 2

A plurality of PI films and a plurality of carbon papers were provided. The PI films and the carbon papers were alternately stacked together to form a laminate. 15 layers of PI films were between each two adjacent carbon papers.

The laminate was put into a heating chamber for vacuum carbonization. The heating chamber was heated for 11 hours from room temperature until a carbonization temperature of 1500° C. was achieved, and then the laminate was heated at the carbonization temperature of 1500° C. for 48 hours. An intermediate product was thereby achieved.

The intermediate product was put into a high temperature graphite furnace. The intermediate product was heated by high frequency heating method for 9 hours from room temperature until a graphitization temperature of 2800° C. was reached, and then the intermediate product was heated at the graphitization temperature of 2800° C. for 56 hours, thereby a PI artificial graphite was achieved.

The PI artificial graphite was cut into smaller pieces and added into NMP to form a semi-solid liquid mixture. The PI artificial graphite had a mass percentage of 0.5% of the total mass of the semi-solid liquid mixture. The semi-solid liquid mixture was put into a high energy separator, and electrical power of 500 W was applied to the high energy separator. Then the semi-solid liquid mixture was stripped by the high energy separator for about 10 minutes, thereby a graphene suspension was achieved. Further, the graphene suspension was subjected to centrifugal separation at a rotational speed of about 5000 rpm, thereby solid graphene was achieved.

### Embodiment 3

A plurality of PI films and a plurality of carbon papers were provided. The PI films and the carbon papers were alternately stacked together to form a laminate. 10 layers of PI films were between each two adjacent carbon papers.

The laminate was put into a heating chamber for vacuum carbonization. The heating chamber was heated for 11 hours from room temperature until a carbonization temperature of 1500° C. was achieved, and then the laminate was heated at the carbonization temperature of 1500° C. for 48 hours, thereby an intermediate product was achieved.

The intermediate product was put into a high temperature graphite furnace. The intermediate product was heated by high frequency heating method for 9 hours from room temperature until a graphitization temperature of 2800° C. was achieved, and then the intermediate product was heated at the graphitization temperature of 2800° C. for 56 hours, thereby a PI artificial graphite was achieved.

The PI artificial graphite was cut into smaller pieces and added into NMP to form a semi-solid liquid mixture. The PI artificial graphite had a mass percentage of 1% of the total mass of the solid liquid mixture. The semi-solid liquid mixture was put into a high energy separator, and electrical power of 900 W was applied to the high energy separator. Then the semi-solid liquid mixture was stripped by the high energy separator for about 20 minutes, thereby a graphene suspension was achieved. Further, the graphene suspension was subjected to centrifugal separation at a rotational speed of about 10000 rpm, thereby solid graphene was achieved.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A method for making a graphene comprising:
providing a plurality of polyimide films;
providing a plurality of carbon papers;
stacking the polyimide films and the carbon papers alternately to form a laminate;
carbonization treating the laminate to form an intermediate product;
graphitization treating the intermediate product to form a polyimide artificial graphite; and
stripping the polyimide artificial graphite to form grapheme.

2. The method of claim 1, wherein at least ten layers of polyimide films are between every two adjacent carbon papers of the laminate.

3. The method of claim 1, wherein the polyimide film has a thickness of about 10 μm to about 100 μm.

4. The method of claim 1, wherein a method for carbonization treating the laminate comprising:
putting the laminate into a heating chamber of a vacuum carbonization furnace;
heating the heating chamber to a carbonization temperature of about 800° C. to about 2000° C.; and
heating the laminate at the carbonization temperature for about 40 hours to about 50 hours.

5. The method of claim 4, wherein a duration of heating the heating chamber to a carbonization temperature of about 800° C. to about 2000° C. is in a range from about 9 hours to about 15 hours.

6. The method of claim 1, wherein a method for graphitization treating the intermediate product comprising:
putting the intermediate product into a heating cavity of a high temperature graphite furnace;
heating the heating cavity to a temperature of about 2000° C. to about 3300° C.; and
heating the intermediate product at the graphitization temperature for about 50 hours to about 60 hours.

7. The method of claim 6, wherein a duration of heating the heating chamber to a graphitization temperature of about 2000° C. to about 3300° C. is in a range from about 6 hours to about 12 hours.

8. The method of claim 1, wherein the polyimide artificial graphite has an adhesively layered structure.

9. The method of claim 1, wherein the polyimide artificial graphite has a thickness of about 5 μm to about 70 μm.

10. The method of claim 1, wherein the polyimide artificial graphite has a planar heat conduction coefficient in a range of about 1200 W/(m*K) to about 1600 W/(m*K).

11. The method of claim 1, wherein the vertical heat conduction coefficient is in a range of about 10 W/(m*K) to about 15 W/(m*K).

12. The method of claim 1, wherein a method for stripping the polyimide artificial graphite is mechanical stripping, oxidation reduction, liquid phase separation, thermal delamination, super critical delamination, or super high acoustic wave vibration delamination.
